(19) United States
(12) Patent Application Publication
(10) Pub. No.: US 2004/0213018 A1
(43) Pub. Date: Oct. 28, 2004

(54) Illumination device and liquid crystal display apparatus

(75) Inventor: Hiroshi Torihara, Matsusaka (JP)

Correspondence Address: NIXON & VANDERHYE, PC, 1100 N GLEBE ROAD, 8TH FLOOR, ARLINGTON, VA, 22201-4714, US

(73) Assignee: Sharp Kabushiki Kaisha, Osaka (JP)

(21) Appl. No.: 10/813,434

(22) Filed: Mar. 31, 2004

(30) Foreign Application Priority Data
Mar. 31, 2003 (JP) 2003-097360

(51) Int. Cl. G02F 1/1335; F21V 7/04

(52) U.S. Cl. 362/561; 349/62; 362/31; 362/559; 362/560

(57) ABSTRACT

An illumination device for illuminating a liquid crystal panel having a frame area and an effective display area surrounded by the frame area includes a light source for emitting light; an optical conductor including a light incident surface on which light emitted by the light source in allowed to be incident, a light output surface from which the light is allowed to be output, and a projection projecting from the light incident surface; and a light scattering section for scattering light, the light scattering section including an engaging portion which is engageable with the projection. The optical conductor and the light scattering section are located such that is an end of the projection of the optical conductors located outside the effective display area of the liquid crystal panel.

This non-provisional application claims priority under 35 U.S.C., §119(a), on Patent Application No. 2003-097360 filed in Japan on Mar. 31, 2003, the entire contents of which are hereby incorporated by reference.

### BACKGROUND OF THE INVENTION

1. Field of the Invention

The present invention relates to an illumination device and a liquid crystal display apparatus including the illumination device. More specifically, the present invention relates to an illumination device for illuminating a liquid crystal panel, and a liquid crystal display apparatus including the illumination device and the liquid crystal panel (for example, a transmission type liquid crystal panel or a transmission type liquid crystal panel with a reflection function).

2. Description of the Related Art

One of the technologies required for a liquid crystal display apparatus including a liquid crystal panel having an effective display area and an illumination device for illuminating the liquid crystal panel is frame reduction.

“Frame reduction” serves to reduce the size of a frame area surrounding an outer perimeter of the effective display area of the liquid crystal panel to a minimum possible size.

In order to comply with the demand for frame reduction, the present inventor accumulated studies, developed frame reduction technology usable for mass production, realized frame reduction of liquid crystal display apparatuses, and proposed the technology in Japanese Laid-Open Publication No. 2000-235805. Actual commercial products incorporating this technology include, for example, liquid crystal display apparatuses for car navigation. The liquid crystal display apparatus disclosed in Japanese Laid-Open Publication No. 2000-235805 will be described with reference to FIG. 6.

FIG. 6 shows a cross-sectional view of one end portion of a conventional liquid crystal display apparatus 200.

The liquid crystal display apparatus 200 includes an illumination device 210 and a liquid crystal panel 220 provided on the illumination device 210. The illumination device 210 includes a cylindrical fluorescent tube 201, a light scattering resin section 202, a reflective plate 203, an optical conductor 204, a lower diffusion sheet 205, a prism sheet 206, and an upper diffusion sheet 207.

A rear housing 231 is formed of a metal material and has a recessed shape. The illumination device 210 is accommodated in the rear housing 231.

The cylindrical fluorescent tube 201 is a linear light source for illuminating a light incident surface 204a of the optical conductor 204. The cylindrical fluorescent tube 201 is located in an area surrounded by the light incident surface 204c, the light scattering resin section 202 and the reflective plate 203.

The light scattering resin section 202 has a step, and the two portions forming the step have different thicknesses.

The reflective plate 203 has a function of reflecting light leaking from the optical conductor 204 back to the optical conductor 204.

The optical conductor 204 propagates therein light incident on the light incident surface 204a and uniformly outputs the light from the light output surface 204a toward the liquid crystal panel 220.

The optical conductor 204 contains a light-transmissive resin, for example, a transparent resin.

The optical conductor 204 includes a thin plate portion 204d projecting outward from the light incident surface 204a. The thinner portion 204d has a prescribed thickness and is formed of a light-transmissive resin, for example, a transparent resin. The thin plate portion 204d is carried by a thinner portion of the light scattering resin section 202, which is provided below the thin plate portion 204d. The illumination device 210 is located such that an outer end of the overlapping thin plate section 204d/thinner portion of the light scattering resin section 202, i.e., an end b of the thin plate section 204d, is in substantially the same plane as a border plane a between an effective display area A and a frame area of the liquid crystal panel 220.

The lower diffusion sheet 205, the prism sheet 206 and the upper diffusion sheet 207 perform optical processing, such as diffusion or the like, on light which is output from the optical conductor 204.

The liquid crystal display apparatus 200 can realize a certain degree of display quality in the frontal viewing direction by (i) optimizing the scattering ability of the light scattering resin section 202, and (ii) optimizing the combination of the lower diffusion sheet 205, the prism sheet 206 and the upper diffusion sheet 207 provided on the light scattering resin section 202 and the optical conductor 204.

Another example of the frame reduction technology is realized by a liquid crystal display apparatus disclosed by Japanese Laid-Open Publication No. 11-72626, which will be described with reference to FIG. 7.

FIG. 7 is a cross-sectional view of one end portion of a conventional liquid crystal display apparatus 300.

The liquid crystal display apparatus 300 includes an illumination device 310 and a liquid crystal panel 320 provided on the illumination device 310. The illumination device 310 includes a cylindrical fluorescent tube 301, a reflective plate 303, an optical conductor 304, a lower diffusion sheet 305, and an upper diffusion sheet 307. The liquid crystal display apparatus 300 is specifically different from the liquid crystal display apparatus 200 in the structure of the optical conductor 304.

The optical conductor 304 has an end surface 304a and a thin plate portion 304d projecting outward from the end surface 304o. The end surface 304o and the thin plate portion 304d form a light incident surface having an L-shaped cross-section. The optical conductor 304 propagates therein light incident on the light incident surface and outputs the light from a light output surface 304a. The cylindrical fluorescent tube 301 is located in an area surrounded by the light incident surface and the reflective plate 303.

The thin plate portion 304d of the optical conductor 304 has a surface 340, which has a plurality of prism surfaces 340a. The prism surfaces 340a are angled at 30° to 60° with respect to the other portion of the surface 340. The prism surfaces 340a reflect the light from the cylindrical fluorescent tube 301 toward a central portion of the optical conductor 304 as indicated by the arrows. This restricts the amount of light which is output from the surface 340 toward the liquid crystal panel 320, and also improves the uniformity of the light output surface 304a.

In the liquid crystal display apparatus 300, the optical conductor 304 can be formed of a single material, and thus can advantageously be produced at low cost.

The liquid crystal display apparatus 200 disclosed by Japanese Laid-Open Publication No. 2000-235805 has the following problems. A certain degree of display quality is realized in the frontal viewing direction as described above, but not in an oblique direction. In the oblique direction, the viewer is annoyingly aware of the existence of an outer end of the overlapping thin plate section 204d/thinner portion of the light scattering resin section 202, i.e., the end b of the thin plate section 204d (hereinafter, also referred to as a “border b”). The overlapping ratio in the thickness direction between the scattering resin section 202 and the thin plate portion 204d changes at the border b and the vicinity thereof. Therefore, when the liquid crystal panel is seen in an oblique direction, the light transmittance is significantly lower outside the border b than inside the border b, resulting in a discontinuous change in luminance. Due to the resultant difference in the transmittance spectrum, the hue changes at the border b. As a result, products including the liquid crystal display apparatus 200 may not sufficiently satisfy the demands of the market and/or customers.

Moreover, a liquid crystal display apparatus having a more narrowed frame area is desired. It is strongly desired to realize such a narrower frame area, improve the uniformity of the light output surface, and realize a continuous change of luminance when the liquid crystal panel is seen in an oblique direction.

The liquid crystal display apparatus 300 disclosed by Japanese Laid-Open Publication No. 11-72626 has the following problem. Although the number of components are small since the optical conductor 304 is formed of one material, the prism surfaces 340 are difficult to process. Therefore, the present inventor has been attempting to solve this problem by combining two types of optical materials.

### SUMMARY OF THE INVENTION

According to one aspect of the invention, an illumination device for illuminating a liquid crystal panel having a frame area and an effective display area surrounded by the frame area includes a light source for emitting light; an optical conductor including a light incident surface on which light emitted by the light source is allowed to be incident, a light output surface from which the light is allowed to be output, and a projection projecting from the light incident surface; and a light scattering section for scattering light, the light scattering section including an engaging portion which is engageable with the projection. The optical conductor and the light scattering section are located such that an end of the projection of the optical conductor is located outside the effective display area of the liquid crystal panel.

In one embodiment of the invention, the projection includes a thin plate portion which is shaped like a thin plate.

In one embodiment of the invention, the projection is located closer to the light output surface than a bottom surface of the optical conductor facing the light output surface.

In one embodiment of the invention, the light scattering section includes a plate-like light scattering section.

In one embodiment of the invention, the light scattering section includes a first portion and a second portion which is thinner than the first portion, and the engaging portion has a step formed by the first portion and the second portion. The projection is located so as to overlap with a surface of the second portion.

In one embodiment of the invention, the light source includes a linear light source.

In one embodiment of the invention, a surface of the first portion of the light scattering section, a surface of the projection of the optical conductor, and the light output surface of the optical conductor are substantially in an identical plane with each other.

In one embodiment of the invention, the light source is structured such that an area of a portion of the light source facing the light incident surface of the optical conductor is larger than an area of a portion of the light source facing the light scattering section.

In one embodiment of the invention, the light source has an elliptical cross-section.

In one embodiment of the invention, the light source is located such that a longer axis direction of the elliptical cross-section is substantially perpendicular to a direction vertical to the light incident surface of the optical conductor.

In one embodiment of the invention, the light source is a fluorescent tube having at least one bending portion, and at least one portion of the fluorescent tube is processed to have an elliptical cross-section.

In one embodiment of the invention, the light source is provided with a first electrode to which a first voltage is allowed to be applied and a second electrode to which a second voltage lower than the first voltage is allowed to be applied. The at least one portion of the fluorescent tube which is processed to have an elliptical cross-section is located closer to the first electrode than the second electrode.

In one embodiment of the invention, the light source includes a fluorescent tube processed to have an elliptical cross-section and an electrode which is not processed to have an elliptical cross-section.

In one embodiment of the invention, the ratio of the length of a longer axis of the elliptical cross-section with respect to the length of a shorter axis of the elliptical cross-section is 0.6 or greater and less than 1.0.

In one embodiment of the invention, the fluorescent tube is processed to have an elliptical cross-section. With respect to the fluorescent tube before being processed, the post-processing fluoroscent tube has a voltage at the start of lighting increased by more than 0% and +15% or less, has a driving voltage increased by more than 0% and +10% or less, and an average outer surface luminance changed by within ±15% inclusive.

In one embodiment of the invention, an end of the second portion of the light scattering section is located inside the light incident surface and is in contact with the optical conductor.

In one embodiment of the invention, the illumination device further includes an optical sheet located on the light output surface.

In one embodiment of the invention, the optical sheet includes a combination of a low turbidity diffusion sheet and a high turbidity diffusion sheet.

In one embodiment of the invention, the optical sheet includes a combination of a selective polarization reflective section and a high turbidity diffusion sheet.

In one embodiment of the invention, the illumination device further includes a fixation section located below the light incident surface of the optical conductor; and a reflection section for reflecting light which is output from a bottom surface of the optical conductor which faces the optical output surface of the optical conductor, the reflection section being located between the fixation section and the optical conductor.

In one embodiment of the invention, a surface of the reflection section and the bottom surface of the optical conductor are in contact with each other below the light incident surface of the optical conductor.

According to another aspect of the invention, a liquid crystal display apparatus includes an illumination device according to claim 1; and a transmissive liquid crystal panel for performing display by allowing light emitted by the illumination device to transmit therethrough or shielding the light.

According to still another aspect of the invention, a liquid crystal display apparatus includes the above-described illumination device; and a transmissive liquid crystal panel having a reflection function for performing display by allowing light emitted by the illumination device to transmit therethrough or shielding the light, and also performing display by reflecting external light.

Owing to the above-described structure, the present invention provides the following functions.

In an illumination device according to the present invention, the end of the projection of the optical conductor is outside the effective display area of the liquid crystal panel. Therefore, a higher luminance continuity at the light output surf ace than that of the conventional illumination device is guaranteed. When the viewer watches the liquid crystal panel placed on the illumination device, the viewer is not aware of the end of the projection of the optical conductor in the frontal viewing direction or an oblique direction. Thus, a high display quality is guaranteed by uniform display.

According to the present invention, the linear light source having an elliptical cross-section, for example, an elliptical fluorescent tube is used. As compared to the case where a circular fluorescent tuba is used, the size of the projection of the optical conductor is shortened in a direction parallel to the light output surface. Therefore, an illumination device having a very narrow frame area can be realized. In the case where the light source is provided such that the longer axis direction is substantially perpendicular to a direction vertical to the light incident surface of the optical conductor, the outer surface luminance in the longer axis direction is lower than that of the circular fluorescent tube. Thus, the luminance change in the frame area of the illumination device can be suppressed. Since the outer surface luminance in the shorter axis direction is higher than that of the circular fluorescent tube, the amount of light incident on the optical conductor increases and the overall luminance of the illumination device can be improved. Thus, the illumination device according to the present invention has a very narrow frame area strongly demanded by the market and the customers can be realized, and also provides a high luminance since the high level of electrical and optical characteristics of the conventional illumination device are maintained.

A fixation section used for fixing the illumination device to, for example, a housing is provided below the light incident surface. Owing to such a structure, the bottom surface of the optical conductor in the vicinity of the light incident surface and the reflective plate have a reduced gap therebetween, or are in contact with each other. The amount of light coming into this gap can be reduced or made zero. This suppresses or prevents unnecessary reflection of the stray light coming into a space between the bottom surface of the light incident surface of the optical conductor and the reflective plate. This reduces or prevents abnormal luminance variance and luminance change in the vicinity of the light incident surface of the optical conductor. Accordingly, by providing the fixation section as described above, a liquid crystal display apparatus having a superior display quality than that of the conventional liquid crystal display apparatus can be provided.

The present invention is applicable to fluorescent tubes having a straight, generally C-shaped, generally L-shaped, or generally O-shaped planar shape. A portion of the fluorescent tube along which the frame area needs to be narrowed is processed to have an elliptical cross-section. In this manner, a very narrow frame area desired by the market or the customers can be realized.

The elliptical fluorescent tube may be formed by changing the shape of the cross-section of a circular fluorescent tube by for example, deformation. Therefore, even after the processing, the fluorescent tube maintains a cross-sectional area which is sufficient for normal glow discharge. Even an increase in the inner, enclosed gas pressure can be suppressed to be small. Accordingly, the electrical and optical characteristics of the post-processing fluorescent tube are not significantly different from those of the circular fluorescent tube. The voltage at the start of lighting is increased by +15% or less, the driving voltage is increased by +10% or less, an the average outer surface luminance is increased by within ±15% inclusive. Therefore, conditions for optical designing and for the illumination device can be similar to those of the conventional liquid crystal display apparatus. The shorter axis/longer axis ratio in limited to 0.6 or greater and less than 1.0. Thus, a sufficient margin for processing is obtained.

The present invention provides a transmission type liquid crystal display apparatus and a transmission type liquid crystal display apparatus having a reflection function, which have a very narrow frame area and electrical and optical characteristics equal to those of the conventional liquid crystal display apparatus, which provide a high luminance and a high uniformity, and which have a satisfactory display quality even seen in an oblique direction.

Thus, the invention described herein makes possible the advantages of providing an illumination device and a liquid crystal display apparatus including the illumination device, having a more narrowed frame area, an improved uniformity of both the light output surface and display surface, and having continuous change of luminance when the liquid crystal panel is seen in an oblique direction, and thus having a high degree of optoelectric characteristic.

These and other advantages of the present invention will become apparent to those skilled in the art upon reading and understanding the following detailed description with reference to the accompanying figures.

### BRIEF DESCRIPTION OF THE DRAWINGS

FIG. 1 is a partial cross-sectional view of a liquid crystal display apparatus according to the present invention;

FIG. 2 is a plan view of the liquid crystal display apparatus shown in FIG. 1;

FIG. 3 is a plan view illustrating a partial structure of a fluorescent part including a fluorescent tube;

FIG. 4A is a cross-sectional view of FIG. 3 taken along line B-B′;

FIG. 4B is a cross-sectional view of FIG. 3 taken along line C-C′;

FIG. 5 is a graph illustrating the relative luminance at various points between a frame area and the center of the effective display area of an illumination device according to the present invention and a conventional illumination device;

FIG. 6 is a cross-sectional view of a conventional liquid crystal display apparatus; and

FIG. 7 is a cross-sectional view of another conventional liquid crystal display apparatus.

### DESCRIPTION OF THE PREFERRED EMBODIMENTS

Hereinafter, the present invention will be described by way of illustrative examples with reference to the accompanying drawings.

### Embodiment 1

Hereinafter, a structure of an illumination device and a liquid crystal display apparatus including the illumination device according to the present invention will be described. Subsequently, test results of an optical sheet provided on an optical conductor of the illumination device will be discussed.

A structure of an illumination device and a liquid crystal display apparatus including the same will be first described.

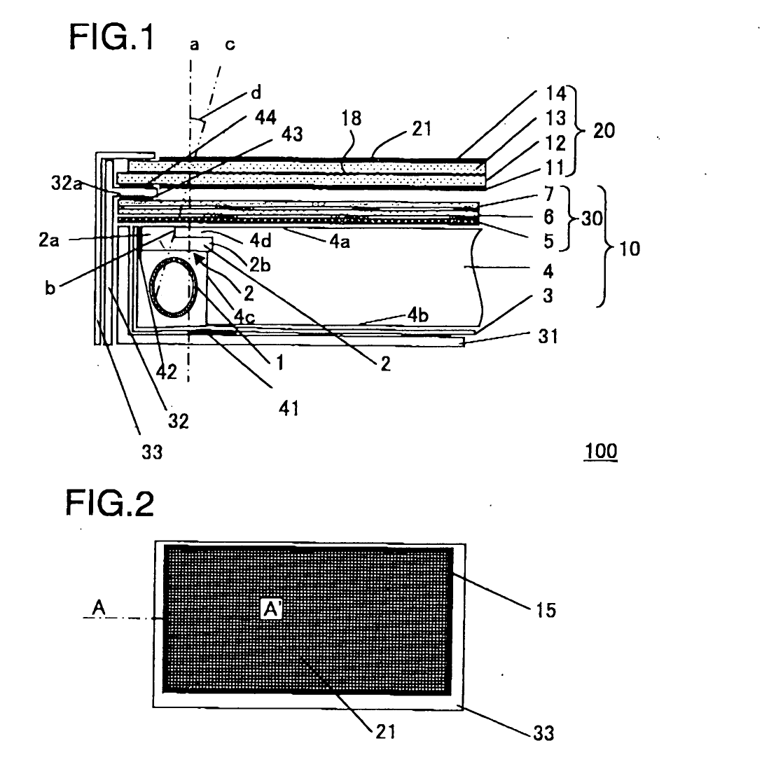

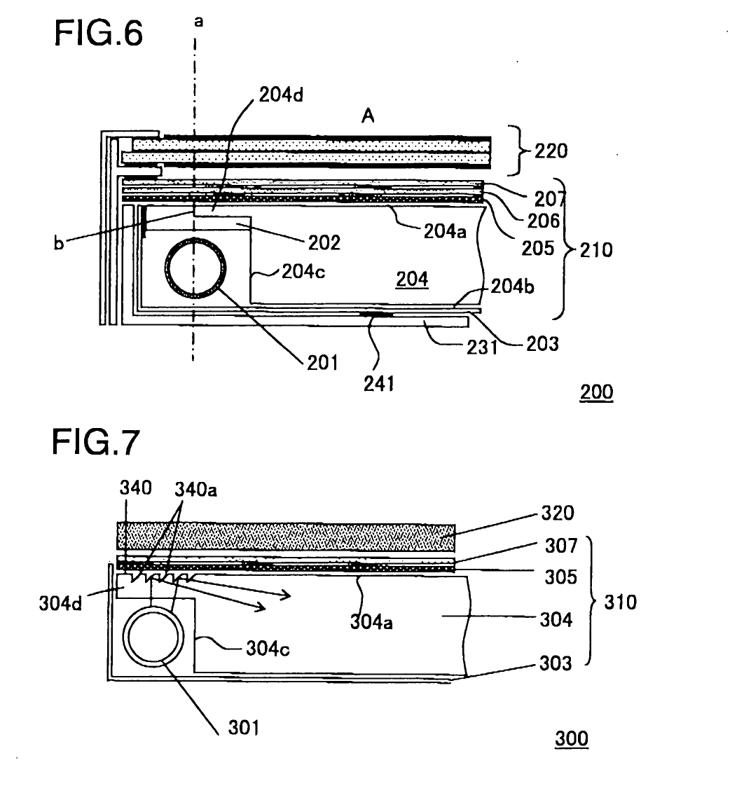

FIG. 1 shows 8 partial cross-sectional view of a liquid crystal display apparatus 100 according to the present invention. FIG. 2 is a top view of the liquid crystal display apparatus 100. The cross-sectional view of FIG. 1 is along line A-A′ of FIG. 2. The cross-sectional views of FIGS. 6 and 7 mentioned above are taken along corresponding lines of the respective liquid crystal display apparatus to line A-A′ in FIG. 2.

As shown in FIG. 1, the liquid crystal display apparatus 100 includes a liquid crystal panel 20 and an illumination device 10 for illuminating the liquid crystal panel 20. The liquid crystal display apparatus 100 further includes a rear housing 31, an inner housing 32 and a front housing 33.

The liquid crystal panel 20 includes a frame area 22 and an effective display area 21 surrounded by the frame area 22. The liquid crystal panel 20 is located on the illumination device 10. The liquid crystal panel 20 is a transmission type liquid crystal panel or a transmission type liquid crystal panel with a reflection function.

The illumination device 10 includes a fluorescent tube 1, a light scattering resin section 2 acting as a light scattering section, a reflective plate 3, an optical conductor 4, a lower diffusion sheet 5, a prism sheet 6, and an upper diffusion sheet 7. The lower diffusion sheet 5 the prism sheet 6, and the upper diffusion sheet 7 are included in an optical sheet 30.

The fluorescent tube 1 has an elliptical cross-section. In the following description, a fluorescent tube having an elliptical cross-section will be referred to also as an “elliptical fluorescent tube”. The fluorescent tube 1 has an elliptical cross-section throughout the entire length thereof in this example, but may partially have an elliptical cross-section. Such a fluorescent tube is also referred to as an “elliptical fluorescent tube”.

In this example, the fluorescent tube 1 is a linear light source for illuminating a light incident surface 4a of the optical conductor 4. In this example, the fluorescent tube 1 is a linear light source, but the light source of the present invention is not limited to a linear light source and may be any light source.

The fluorescent light 1 is located in an area surrounded by the light incident surface 4c of the optical conductor 4, the light scattering resin section 2 and the reflective plate 3, such that a longer axis of the fluorescent light 1 is substantially right angled to a direction vertical to the light incident surface 4c.

The light scattering resin section 2 has two portions 2a and 2b having a step interposed therebetween and having different thicknesses. In more detail, the portion 2a is thicker than the portion 2b. The light scattering resin section 2 is one example of a light scattering section for scattering light. The light scattering resin section 2 may be a plate-like element. In this example, the light scattering resin section 2 is formed of a material obtained by a combination of polycarbonate (PC) resin acting as a light scattering resin and titanium oxide or zinc oxide acting as a light scattering material.

The reflective plate 3 is located in the vicinity of a bottom surface 4b of the optical conductor 4, and has a function of reflecting light leaking from the optical conductor 4 and light directed to the reflective plate 3 back to the optical conductor 4. The reflective plate 3 is one example of a reflection section for reflecting the light toward the optical conductor 4.

The optical conductor 4 is partially sectioned off and contains a light-transmissive resin, for example, a transparent resin.

The optical conductor 4 propagates therein light which is incident on the light incident surface 4c, which is an effective incident surface of the optical conductor 4, and uniformly outputs the light from a light output is surface 4a toward the liquid crystal panel 20. The light output surface 4a is a top surface of the optical conductor 4.

In the optical conductor 4, the bottom surface 4b is opposed to a light output surface 4a, and the bottom surface 4b has an engraved pattern.

The optical conductor 4 has a thin plate portion 4d projecting outward from the light incident surface 4a. The thin plate portion 4d has a prescribed thickness and is formed of a light-transmissive resin or a transparent resin. As the light-transmissive resin or the transparent resin, polymethylmechacrylate (PMMA) resin may be used.

In this example, a projection projecting from the light incident surface 4a has a shape of a thin plate and is referred to as the “thin plate portion”. Such a projection is not limited to be shaped as a thin plate. The thin plate portion 4d is one example of a projection projecting from the light incident surface 4c. Exemplary forms of the projection are described in, for example, the U.S. Pat. No. 6,412,969, which is incorporated herein by reference.

In this example, the thin plate portion 4d is structured such that a surface thereof in substantially in the same plane as the light output surface 4a of the optical conductor 4, but is not limited to such a structure. The thin plate portion 4d may be provided closer to the light output surface 4a than the bottom surface 4b.

In this example, a surface of the portion 2a of the optical scattering resin section 2, a surface of the thin plate portion 4d and the light output surface 4a of the optical conductor 4 are structured so as to be substantially in the same plane.

The portion 2b of the optical scattering resin section 2 and the thin plate portion 4d of the optical conductor 4 are overlapping in the thickness direction, and the portion 2b, which is provided below the thin plate portion 4d, carries the thin plate portion 4d.

The portion 2a and the portion 2b have a step interposed therebetween, and the thin plate portion 4d is provided on the surface of the portion 2b. The present invention is not limited to such a structure. A portion of the light scattering resin section 2 may be engaged with the thin plate portion 4d. Specifically, the light scattering resin section 2 may have an engagement section which is engageable with the thin plate portion 4d.

In this example, an inner end of the portion 2b is in contact with the optical conductor 4 at a position inner to the light incident surface 4c of the optical conductor 4.

With reference to FIG. 2, the effective display area 21 of the liquid crystal panel 20 is surrounded by a black matrix 15. The black matrix 15 is provided in a gap between the effective display area 21 and the front housing 33, and corresponds to the frame area 22.

An outer end of the overlapping thin plate section 4d/portion 2b of the light scattering resin section 2. i.e., an end b of the thin plate section 4d, is located outside a border plane a between the effective display area 21 and the frame area 22.

Referring again to FIG. 1, the optical sheet 30, which is a combination of the lower diffusion sheet 5, the prism sheet 6 and the upper diffusion sheet 7, is provided above the light output surface 4a of the optical conductor 4, and performs optical processing, such as diffusion or the like, on light from the optical conductor 4. In this example, D123 produced by Tsujiden Co., Ltd. is used as the lower diffusion sheet 5, BEFII produced by Sumltomo 3M is used as the prism sheet 6, and D117 produced by Tsujiden Co., Ltd. is used as the upper diffusion sheet 7.

The liquid crystal panel 20 includes a liquid crystal layer 18 containing liquid crystal molecules (not shown) between an upper glass plate 13 and a lower glass plate 12 each having an, electrode (not shown). A front polarizing plate 14 is provided outside the upper glass plate 13, and a rear polarizing plate 11 is provided outside the lower glass plate 12. A voltage is applied to the liquid crystal layer 18 to change the orientation state of the liquid crystal molecules. Thus, light emitted by the illumination device 10 is modulated to change the polarization state of the light. As a result, the light is transmitted through the rear polarizing plate 11 and the front polarizing plate 14, or the light is scattered and/or absorbed by the rear polarizing plate 11 and the front polarizing plate 14. Thus, the liquid crystal display apparatus 100 displays images.

The rear housing 31 contains a metal material and has a recessed shape. The illumination device 10 is located in the rear housing 31 and is fixed to the rear housing 31 by two-sided adhesive tapes 41 and 42 acting as a fixing sub material. The fixing sub material is one example of a fixation section for fixing the illumination device 10.

The two-sided adhesive tape 41 is located below the light incident surface 4c of the optical conductor 4 and between the reflective plate 3 and an upper surface of the rear housing 31. The two-sided adhesive tape 42 is located between the light scattering resin section 2 and a side surface of the reflective plate 3.

The inner housing 32 is located to the side of the illumination device 10 and the rear housing 31. The inner housing 32 contains a resin. The inner housing 32 has a projecting portion 32a projecting inward from a side surface thereof toward a position above the illumination device 10.

A two-sided adhesive tape 43 is located at an end of the upper diffusion sheet 7, and fixes the illumination device 10 on a bottom surface of the projecting portion 32a of the inner housing 32.

The liquid crystal panel 20 is placed on the projecting portion 32a of the inner housing 32.

A two-sided adhesive tape 44 is located at an end of the lower glass plate 12 of the liquid crystal panel 20, and fixes the liquid crystal panel 20 on a top surface of the projecting portion 32a of the inner housing 32.

The illumination device 10, the liquid crystal panel 20, the rear housing 31 and the inner housing 32 are covered with the lid-type front housing 33 which is open in an area corresponding to the effective display area 21 of the liquid crystal panel 20 and the black matrix 15 surrounding the effective display area 21 (FIGS. 1 and 2).

The liquid crystal display apparatus 100 in this example realizes a high degree of display quality in the frontal viewing direction as follows, similar to the conventional liquid crystal display apparatus 200 shown in FIG. 6. First, the scattering ability of the light scattering resin section 2 is optimized. Second, the combination of the lower diffusion sheet 5 and the upper diffusion sheet 7, which is a part of the optical sheet 30 provided on the optical conductor 4 is optimized, such that the light is appropriately scattered by the lower diffusion sheet 5 and the upper diffusion sheet 7, and the light scattered by the light scattering resin section 2 and the light scattered by the engraved pattern of the bottom surface 4b of the optical conductor 4 are well balanced.

In an oblique direction, the outer end of the overlapping thin plate section 4d/portion 2b of the light scattering resin section 2, i.e., the end or border b of the thin plate section 4d, is located outside the border plane a between the effective display area 21 and the frame area 22. Therefore, even when the liquid crystal panel 20 is observed in a direction c which is angled with respect to the border plane a by an angle d, the viewer is not aware of the existence of the outer end of the overlapping thin plate section 4d/portion 2b of the light scattering resin section 2. Therefore, no discontinuous change in luminance occurs, and a satisfactory display state is provided.

Next, combinations of the lower diffusion sheet 5, the prism sheet 6 and the upper diffusion sheet 7 to form the optical sheet 30 will be discussed.

According to the present invention, the upper diffusion sheet 7 is formed of a highly light-transmissive material as compared to the upper diffusion sheet 207 of the conventional liquid crystal display apparatus 200 shown in FIG. 6.

In the liquid crystal display apparatus 200, the distance between the end b of the thin plate portion 204d and the inner end (right end in FIG. 6) of the light scattering resin section 202 is about 2 mm. The end b corresponds to the border plane a between the effective display area A and the frame area of the liquid crystal panel 220. In order to prevent the viewer from recognizing a border between the overlapping thin plate section 204d/portion 202b of the light scattering resin section 202 and the main part of the optical conductor 204, a combination of the lower diffusion sheet 205 and the upper diffusion sheet 207 which provides an appropriate scattering effect is needed. Thus, as the diffusion sheet 207, a sheet having a turbidity of 77% and the vicinity thereof such as, for example, D120 produced by Tsujiden Co., Ltd. needs to be used.

In the liquid crystal display apparatus 100 in this example, by contrast, the distance between the border plane a and the inner end of the light scattering resin section 2 can be shortened to be about 1 mm, by for example, changing the shape of the lamp rubber holder and changing the specifications of the lamp in consideration of the production error. Accordingly, even with a lower turbidity of the upper diffusion sheet 7, a clear hue difference due to the difference in the transmittance spectrum is not observed as is observed in the conventional liquid crystal display apparatus 200. As a result, illumination has a high uniformity and has a continuous change in luminance.

In the illumination device 10, the turbidity of the upper diffusion sheet 7 (D117UE produced by Tsujiden Co., Ltd.), is 35%, which significantly improves the luminance as compared to the case where a diffusion sheet having a higher turbidity is used. Since the upper diffusion sheet 7 can have a lower turbidity, the degree of design freedom is improved. Instead of the upper diffusion sheet 7, a selective polarizing reflective film such as, for example, DBEFD or DRPFH produced by Sumitomo 3M can also be used.

Table 1 shows the luminance measured with different combinations of diffusion sheets.

TABLE 1

| | | | | Luminance at the | Luminance | |
|---|---|---|---|---|---|---|
| | | Structure of optical sheet | Turbidity of | center of the | at the center | Improvement of luminance as |
| | | Upper diffusion sheet/priom | diffusion sheet | Illumination device | of the panel | compared to the conventional |
| Item | No. | sheet/lower diffusion sheet | [haze] | [cd/m²] | [cd/m²] | liquid crystal display apparatus |
| Present | 1 | D117UE/BEF2/100SXE | 35%/—/89% | 6221.882488 | 494.0 | 31.8% |
| Invention | 2 | D117TF/BEF2/100SXE | 84%/—/89% | 6173.803528 | 490.2 | 30.8% |
| | 3 | D117TY/BEF2/100SXE | 73%/—/89% | 6036.523929 | 479.3 | 27.8% |
| | 4 | 100TL2/BEF2/100SXE | 29%/—/89% | 6173.803526 | 480.2 | 30.8% |
| | 5 | 100TL4/BEF2/100SXE | 46%/—/89% | 6129.722822 | 496.7 | 28.8% |
| | 6 | D117UE/BEF2/100MXE | 35%/—/89% | 5831.234257 | 463.0 | 23.5% |
| | 7 | D117TF/BEF2/100MXE | 84%/—/89% | 5850.125946 | 484.5 | 23.9% |
| | 8 | D117TY/BEF2/100MXE | 73%/—/89% | 5920.854912 | 470.1 | 25.4% |
| | 9 | 100TL2/BEF2/100MXE | 29%/—/89% | 8132.241014 | 488.9 | 29.9% |
| | 10 | 100TL4/BEF2/100MXE | 46%/—/89% | 8086.901783 | 483.3 | 28.9% |
| | 11 | D117UE/BEF2/100LSE | 35%/—/84% | 5811.083123 | 461.4 | 23.1% |
| | 12 | D117TF/BEF2/100LSE | 84%/—/84% | 5895.465896 | 466.1 | 24.8% |
| | 13 | D117TY/BEF2/100LSE | 73%/—/84% | 5788.672544 | 458.7 | 22.6% |
| | 14 | 100TL2/BEF2/100LSE | 29%/—/84% | 5851.38539 | 464.6 | 23.9% |
| | 15 | 100TL4/BEF2/100LSE | 46%/—/84% | 5772.040302 | 458.3 | 22.2% |
| | 16 | D117UE/BEF2/D114 | 35%/—/81% | 5565.491184 | 441.9 | 17.9% |
| | 17 | D117TF/BEF2/D114 | 84%/—/81% | 5526.448383 | 438.8 | 17.0% |
| | 18 | D117TY/BEF2/D114 | 73%/—/81% | 5406.801009 | 428.3 | 14.5% |
| | 19 | 100TL2/BEF2/D114 | 29%/—/81% | 5548.118309 | 440.6 | 17.6% |
| | 20 | 100TL4/BEF2/D114 | 46%/—/81% | 5582.972292 | 441.7 | 17.8% |
| | 21 | D117UE/BEF2/D123 | 35%/—/82% | 5147.355184 | 408.7 | 8.0% |
| | 22 | D117TF/BEF2/D123 | 84%/—/82% | 5158.880176 | 409.6 | 8.3% |
| | 23 | D117TY/BEF2/D123 | 73%/—/82% | 4881.183879 | 386.3 | 6.7% |
| | 24 | 100TL2/BEF2/D123 | 29%/—/82% | 5261.889169 | 417.0 | 11.2% |
| | 25 | 100TL4/BEF2/D123 | 46%/—/82% | 5042.821169 | 400.4 | 6.8% |
| Conventional | 26 | D120/BEF2/D123 | 78%/—/82% | 4583.199982 | 384.7 | [symbol] Reference |
| | 27 | D124/BEF2/D123 | 78%/—/82% | 4721.882469 | 374.8 | |
| | 28 | D121/BEF2/D123 | 78%/—/82% | 4469.7733 | 354.9 | |

Table 1 shows the upper diffusion sheet 7/prism sheet 6/lower diffusion sheet 5 combinations, the turbidity of each of the lower diffusion sheet 5 and the upper diffusion sheet 7, the luminance at the center of the illumination device, the luminance at the center of the liquid crystal panel, and the improvement in luminance of the liquid crystal display apparatus 100 as compared to that of a conventional liquid crystal display apparatus.

Diffusion sheets used as the upper diffusion sheet 7 were, for example, D117TF (Tsujiden Co., Ltd.; turbidity: 64%), D117TY (Tsujiden Co., Ltd.: turbidity: 73%), Lightup 100TL4 (Kimoto; turbidity: 38%), and Lightup 100TL2 (Kimoto; turbidity: 25%). For the lower diffusion sheet 5, various diffusion sheets were used. Only D123 produced by Tsujiden Co., Ltd. was used for the conventional liquid crystal display apparatus, whereas D114 produced by Tsujiden Co., Ltd.; and high turbidity diffusion sheets 100MXE, 100SXE, and 100LSE produced by Kimoto were additionally used for the liquid crystal display apparatus 100 of the present invention.

As can be appreciated from Table 1, a wider variety of combinations of sheets can be used and a higher luminance is obtained according to the present invention. For example, as shown by samples 1 through 5 in the top row in Table 1. when 100SXE was used as the lower diffusion sheet 5, the luminance was improved by about 28% to 32% by using an upper diffusion sheet 7 having a lower turbidity than the diffusion sheets conventionally used (samples 26 through 28 in the bottom row). The luminance at the center of the illumination device was significantly improved to 6037 cd/m² to 6222 cd/m² as compared to the conventional values of 4593 cd/m² to 4722 cd/m².

The luminance at the center of a liquid crystal panel combined with the illumination device was also significantly improved to 479 cd/m² to 494 cd/m² as compared to the conventional values of 355 cd/m² to 375 cd/m². There is substantially no conventional example of realizing a luminance at the center of the liquid crystal panel which is closer to 500 cd/m² without using a selective polarization reflective film. The present invention provides a very useful illumination device 10 and a liquid crystal display apparatus 100 including the illumination device 10 for applications in which the maximum luminance to important.

The above effect is obtained by optimization of the lower diffusion sheet 5 and the upper diffusion sheet 7. As shown by samples 21 through 25, a combination of D123, which was conventionally used for the lower diffusion sheet 5 and an upper diffusion sheet 7 having a low turbidity improved the luminance by about 7% to 11% as compared to the conventional values.

In order to further improve the luminance, tests were performed by varying the turbidity of the lower diffusion sheet 5. Diffusion sheets used as the lower diffusion sheet 5 were 100SXE (Kimoto; turbidity 89%). 100MXE (Kimoto; turbidity 89%). 100LSE (Kimoto; turbidity 84%), D114 (Tsujiden Co. Ltd.; turbidity 81%) and D123 (Tsujiden Co., Ltd.; turbidity 82%). Diffusion sheets used as the upper diffusion sheet 7 were D117UK (Tsujiden Co., Ltd.; turbidity 35%), D117TF (Tsujiden Co., Ltd.; turbidity 64%), D117TY (Tsujiden Co., Ltd.; turbidity 73%), 100TL2 (Kimoto; turbidity 29%) and 100TL4 (Kimoto; turbidity 46%).

As shown by samples 1 through 5, when 100SXE was used as the lower diffusion sheet 5, the luminance was improved by about 28% to 32% as compared to the conventional values. As shown by samples 6 through 10, when 100MXE was used as the lower diffusion sheet 5, the luminance was improved by about 24% to 30% as compared to the conventional values. As shown by samples 11 through 15, when 100LSE was used as the lower diffusion sheet 5, the luminance was improved by about 22% to 25% as compared to the conventional values. As shown by samples 16 through 20, when D114 was used as the lower diffusion sheet 5, the luminance was improved by about 15% to 18% as compared to the conventional values. As shown by samples 21 through 25, when D123 was used as the lower diffusion sheet 5, the luminance was improved by about 7% to 11% as compared to the conventional values.

As also shown in Table 1, regarding the lower diffusion sheet 5, D123 produced by Tsujiden Co., Ltd. conventionally used has a turbidity of 82% and the sheets used for the present invention have a turbidity of 81% to 89%. In terms of the turbidity only, there is substantially no optical difference.

By contrast, regarding the upper diffusion sheet 7, the conventional sheets have a turbidity of 76% to 79%, whereas the sheets used for the present invention have a turbidity of 29% to 73%. As compared to the conventional art, the present invention allows use of a significantly wider variety of diffusion sheets for the upper diffusion sheet 7. This is very useful to comply with the demands of the market, from the demands for uses for which the luminance is the first priority to the demands for well balanced products having both a high luminance and a wider light scattering range.

Since selective polarization reflective films conventionally used do not need to be used for improving the luminance of the illumination device 10 and of the liquid crystal display apparatus 100 including the same the production cost la reduced. Even for the uses requiring low cost, a high luminance illumination device and a liquid crystal display apparatus including the same can be provided.

Special markets of liquid crystal display apparatuses include open cars and racing cars. Especially when driving a vehicle under a high illuminance during the daytime, the driver wears sunglasses or uses a face shield of a helmet. In such a case, the sunglasses or the face shield absorb light and thus the light transmittance to the driver's eyes is lowered. As a result, the display screen of the liquid crystal display apparatus looks darker to the driver than it is actually is. In such uses, it is strongly desired to improve the visibility of the display screen.

In order to comply with such a market demand, the luminance of the liquid crystal display apparatus needs to be improved. This can be realized by improving the transmittance of the liquid crystal panel or the luminance of the illumination device. It is difficult to improve the transmittance of the liquid crystal panel. The reason for this is that the improvement in the transmittance of the liquid crystal panel is only made possible by reducing the width of gate lines and/or source lines and the size of the TFTs provided in the liquid crystal panel, so as to increase the substantial pixel areas. Such an improvement in transmittance results in reduction in the margin for production error, i.e., the production margin. Therefore, it is necessary to perform the management of the production process and inspection very strictly. When process conditions exceeding the margin occur for some reason, there is an undesirable possibility that the production yield of the liquid crystal panels is significantly lowered, which in turn increases the production cost.

As can be appreciated from the above, improving the transmittance of the liquid crystal panel prevents an appropriate production margin from being maintained. The present invention paid attention to and studied matching the axis of the light emitted from the illumination device 10 to the polarization axis of the rear polarizing plate 11 of the liquid crystal panel 20, 80 that the amount of light transmitted through the liquid crystal panel 20 is larger than the amount of light transmitted through the conventional liquid crystal panel 220.

Specifically, a selective polarization reflective film is provided instead of the upper diffusion sheet 7 as the uppermost layer of the illumination device 10 to form an optical sheet, and thus light is more efficiently used. Thus, the axis of the light emitted from the illumination device 10 can be matched to a specific polarization axis. Herein, such a method is referred to as an “effective luminance improvement method” by a selective polarization reflection system. In the following example, the effective luminance improvement method is used for the present invention.

Table 2 shows the luminance measured with different combinations of diffusion sheets in this case.

TABLE 2

| | | Structure of optical sheet | | Luminance at the | Luminance | |
|---|---|---|---|---|---|---|
| | | Selective polarization | Turbidity of | center of the | at the center | Improvement of luminance as |
| | | reflective film/prism | diffusion sheet | Illumination device | of the panel | compared to the conventional |
| Item | No. | sheet/lower diffusion sheet | [haze] | [cd/m²] | [cd/m²] | liquid crystal display apparatus |
| Present | 28 | DBEFD/BEF2/100SXE | —/—/88% | 8542.821158 | 878.3 | 29.4% |
| invention | 30 | DBEFD/BEF2/100MXE | —/—/89% | 8287.153852 | 858.0 | 26.5% |
| | 31 | DBEFD/BEF2/100LSE | —/—/94% | 8084.458438 | 842.7 | 22.6% |
| | 32 | DBEFD/BEF2/D114 | —/—/81% | 7875.082872 | 608.4 | 16.3% |
| | 33 | DBEFD/BEF2/D123 | —/—/82% | 7113.350128 | 884.8 | 7.8% |
| | 34 | DRPFH/BEF2/100SXE | —/—/88% | 7826.862141 | 829.4 | 20.1% |
| | 35 | DRPFH/BEF2/100MXE | —/—/89% | 7680.176322 | 810.8 | 18.6% |
| | 36 | DRPFH/BEF2/100LSE | —/—/84% | 7511.335013 | 588.4 | 13.8% |
| | 37 | DRPFH/BEF2/D114 | —/—/81% | 7122.188247 | 565.5 | 7.8% |
| Conventional | 38 | DRPFH/BEF2/D123 | —/—/82% | 6600.755668 | 524.1 | [symbol] Reference |

Table 2 shows the selective polarization reflective film/prism sheet/lower diffusion sheet combinations, the turbidity of the lower diffusion sheet, the luminance at the center of the illumination device, the luminance at the center of the liquid crystal panel, and the improvement in luminance of the liquid crystal display apparatus as compared to that of the conventional liquid crystal display apparatus 200.

Conventionally, the optical sheet structure used for the effective luminance improvement method by the selective polarization reflection system was DRPFH/BEF2/D123 from the uppermost surface of the illumination device. DRPFH is a special optical film, more specifically, a selective polarization reflective film, produced by Sumitomo 3M. Light is appropriately diffused by the lower diffusion sheet D123 and is scattered by the selective polarization reflective film DRPFH. Thus, a high luminance is realized while the high wide light scattering range is maintained.

As shown by sample 38 in Table 2, the effective luminance improvement method conventionally provided a luminance at the center of the illumination device of 6601 cd/m² and a luminance at the center of the liquid crystal panel of 524 cd/m².

By contrast, according to the present invention, as shown by sample 34 through 37 in Table 2, the luminance at the center of the illumination device was improved to 7122 cd/m² to 7927 cd/m², and the luminance at the center of the liquid crystal panel was improved to about 566 cd/m² to 629 ad/m², also using DRPFH. The luminance was improved by about 8% to 20% as compared to the conventional values.

For samples 29 through 33, DBEFD (Sumitomo 3M) was used as the selective polarization reflective film. In this case, the luminance was improved by about 8% to 29% as compared to the conventional values. With DHEFD, light is less scattered than with DRPFH. Thus, DBEFD is more advantageous than DRPFH for the luminance in the frontal viewing direction. Conventionally, DRPFH, which scatters light to an appropriate degree, is needed in order to continuously change the luminance and suppress the hue change at the border between the effective display area and the frame area. According to the present invention, DBEFD, which scatters light less, can be used instead of DRPFH, so as to further improve the luminance.

In the case where DBEFD to used, a super high luminance close to 700 cd/m² is obtained at the center of the liquid crystal panel as an actually measured value. A liquid crystal panel having such a high luminance is sufficiently used for the above-mentioned special vehicles. Notably, the level of luminance actually required is not determined by a numerical value but by the perception of the users. Therefore, no practical numerical value of the required luminance is known, but it is considered that at least 600 cd/m² is required. Even in consideration of this, an illumination device and a liquid crystal display apparatus including the same according to the present invention can comply with the demands of the special uses.

There is another method for improving the visibility for open cars or motorbikes. In the above example, a transmission type liquid crystal panel is used as the liquid crystal panel 20. Instead, transmission type liquid crystal panels having a reflection function are also available. Such liquid crystal panels perform display, partially using reflected light.

A feature of a liquid crystal display apparatus including a liquid crystal panel having a reflection function is combining both light reflected by the controlled liquid crystal panel and light transmitted through the liquid crystal panel in the daytime. Thus, the luminance of the liquid crystal display apparatus generally relies on the illuminance of external light. Since the liquid crystal panel uses reflected light, the light looks natural to the human eye. Such a liquid crystal display apparatus is referred to as, for example, an “advanced liquid crystal display apparatus”.

A case where the advanced liquid crystal display apparatus is applied to the present invention will now be described.

Table 3 shows the measured luminance of a liquid crystal display apparatus including a liquid crystal panel having a reflection function.

TABLE 3

| | | | | | Improvement |
|---|---|---|---|---|---|
| | | | | | of luminance |
| | | | | | as compared |
| | | | | | to the |
| | | Structure of optical sheet | | | conventional |
| | | Selective polarization | Turbidity of | Luminance at the | liquid crystal |
| | | reflective film/prism | diffusion sheet | center of the panel | display |
| Item | No. | sheet/lower diffusion sheet | [haze] | [cd/m²] | apparatus |
| Present | 39 | DBEFD/BEF2/100SXE | —/—/89% | 380.5 | 33.7% |
| Invention | 40 | DBEFD/BEF2/100MXE | —/—/89% | 369.1 | 29.7% |
| | 41 | DBEFD/BEF2/100LSE | —/—/84% | 360.6 | 26.7% |
| | 42 | DBEFD/BEF2/D114 | —/—/81% | 341.9 | 20.1% |
| | 43 | DBEFD/BEF2/D123 | —/—/82% | 316.9 | 11.3% |
| | 44 | DRPFH/BEF2/100SXE | —/—/89% | 341.8 | 20.1% |
| | 45 | DRPFH/BEF2/100MXE | —/—/89% | 331.6 | 16.5% |
| | 46 | DRPFH/BEF2/100LSE | —/—/84% | 323.8 | 13.8% |
| | 47 | DRPFH/BEF2/D114 | —/—/81% | 307.1 | 7.9% |
| Conventional | 48 | DRPFH/BEF2/D123 | —/—/82% | 284.6 | [symbol] Referance |

Table 3 shows the selective polarization reflective film/prism sheet/lower diffusion sheet combinations, the turbidity of the lower diffusion sheet, the luminance at the center of the liquid crystal panel, and the improvement in luminance of the liquid crystal display apparatus as compared to that of the conventional liquid crystal display apparatus.

The transmittance of the liquid crystal panel having a reflection function is about 53% of the transmittance of the above-described liquid crystal panel. The results shown in Table 3 do not include a reflected light component since the measurement was performed by a method not in consideration of external light. Since actual environmental use is considered to involve sufficient external light, the luminance values must be better than those shown in Table 3.

As shown by sample 48 in Table 3, the luminance at the center of the liquid crystal panel was conventionally about 284 cd/m². There is no problem with this value since a general requirement is 250 cd/m², but it is desirable to have a higher luminance.

Such a higher luminance can be realized by the following three methods. A first method is to improve the luminance by reducing the reflection function of the liquid crystal panel with a reflection functional such that the reflection function of the panel becomes closer to that of a liquid crystal panel without a reflection function. A second method is to improve the correlation between the luminance of the liquid crystal panel and the illuminance of the external light, by improving the reflection function so as to change the illuminance of external light. A third method is to improve the luminance by the illumination device while substantially maintaining the reflection function at the current level.

In general, it is desired to maintain appropriate visibility even under external light. Therefore, an appropriate reflection function is necessary. However, the reflection function cannot be improved to such a level that deteriorates the visibility. The first method has the following problem when the illuminance of external light is extremely high. The reason is that even though the luminance is improved by increasing the transmittance, the absolute difference between the luminance of the liquid crystal panel and the illuminance of the external light cannot be compensated for. The second method has the following problems. Although the luminance of the liquid crystal panel is strongly correlated with the illuminance of external light, external spectrum dependence, which is inherent in the reflection system, cannot be eliminated. This results in the displayed image appearing faded and unpleasant to the viewer. When the illuminance of external light is a middle to low level, the light transmittance through the liquid crystal panel is lowered. As a result, the illuminating light is not sufficiently used and the display is dark. For these reasons, the present inventor tested the third method.

As shown by samples 44 through 47 in Table 3, even when DRPFH, which was conventionally used, was used as the selective polarization reflective film, the luminance was improved by about 8% to 20% as compared to the conventional values. As shown by samples 39 through 43, when DBEFD was used, the luminance was improved by about 11% to 34% as compared to the conventional values. A luminance at the center of the liquid crystal panel of 350 cd/m² or higher can be provided, which sufficiently complies with the demands of the market for a higher luminance.

The luminance of the illumination device 10 in this example is not improved by the simple method of increasing the electric current flowing in the fluorescent tube 1. Therefore, the luminance can be improved without any adverse effect on the life of the illumination device 10, and a high reliability is provided.

### Embodiment 2

In Embodiment 1, various tests were performed in order to improve the structure of illumination device 10 of the liquid crystal display apparatus 100 and the combination of the sheets forming the optical sheet, i.e., the transmittance of the optical sheet. Specifically, the turbidity of the upper diffusion sheet 7 was varied (Table 1). A selective polarization reflective film was used instead of the upper diffusion sheet 7 in order to match the optical axis of the light emitted by the illumination device 10 to a specific polarization axis (Table 2). A selective polarization reflective film was used instead of the upper diffusion sheet 7 in order to provide appropriate visibility even under external light (Table 3). In Embodiment 2, the structure of an elliptical fluorescent tube usable in the present invention and the electrical and optical characteristics thereof will be described.

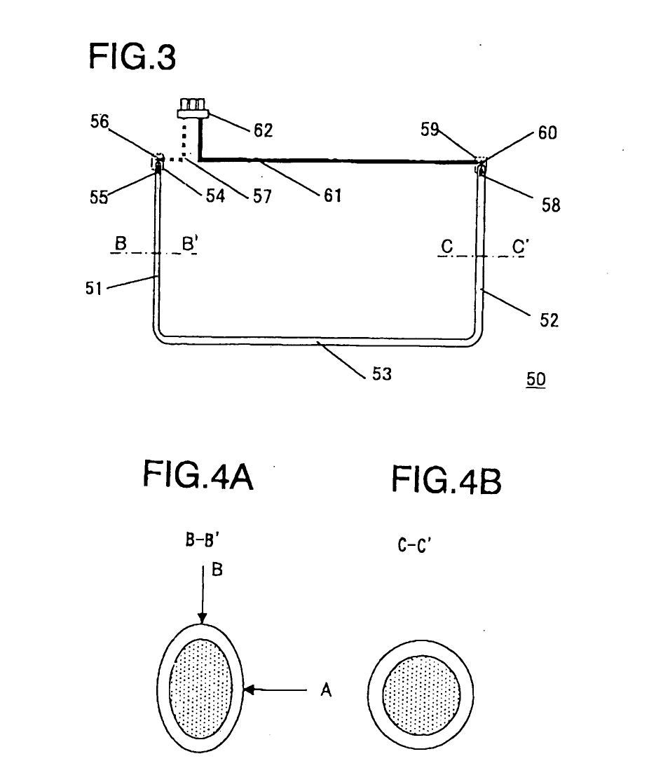

With reference to FIGS. 3 and 4, a specific structure of a fluorescent tube 1 usable for the present invention will be described.

FIG. 3 is a plan view illustrating a partial structure of a fluorescent part 50 including a fluorescent tube 1. FIG. 4A is a cross-sectional view of the fluorescent tube shown in FIG. 3 taken along line B-B′ in FIG. 3. FIG. 4B is a cross-sectional view of the fluorescent tube shown in FIG. 3 taken along line C-C′ in FIG. 3.

The fluorescent tube 1 included in the fluorescent part 60 has a generally C-shaped planar shape and has two bending portions. A high voltage electrode 55 provided at one end of the fluorescent tube is connected to a connector 62 via a soldered portion 56 and a high voltage harness 57. The connector 62 is connected to an inverter circuit (not shown). A low voltage electrode 58 provided at the other end of the fluorescent tube is connected to the connector 62 via a soldered portion 60 and a low voltage harness 61. The one end of the fluorescent tube provided with the high voltage electrode 55, the soldered portion 56, and the end of the high voltage harness 57 provided with the high voltage electrode 55 are covered with a high voltage rubber holder 54. The other end of the fluorescent tube provided with the low voltage electrode 58, the soldered portion 60, and the end of the low voltage harness 61 provided with the low voltage electrode 58 are covered with a low voltage rubber holder 59.

The fluorescent tube 1 includes a short side portion 51, a long side portion 53, and another short side portion 52. The short side portion 51 is continuous with the long side portion 53, and the long side portion 53 is continuous with the short side portion 52.

In the fluorescent tube part 60, the short side portion 51 is provided with the high voltage electrode 55, and a portion which is electrically “hot” is processed to have an elliptical cross-section from the initial state of having a circular cross-section. The short side portion 52 provided with the low voltage electrode 58 and the long side portion 53 connected to the short side portion 52 may also be processed to have an elliptical cross-section. In this example, only the short side portion 51 is processed to have an elliptical cross-section (FIG. 4A) in order to provide a very narrow frame area corresponding to the short side portion 51 and the vicinity thereof. The short side portion 52 and the long side portion 53 are not processed and have a circular cross-section as shown in FIG. 4B.

In this example, the short side portion 51 is processed as described above for the following reason. A fluorescent tube in a discharge state is represented as a resistance in an electric equivalent circuit. In the fluorescent tube having its shape changed as in this example, a portion having an elliptical cross-section (elliptical portion) is represented as a slightly high resistance, and a portion having a circular cross-section (circular portion) is represented as a conventional resistance.

When the inner diameter of the fluorescent tube is decreased or when the gas pressure is increased, the lighting state maintaining voltage increases, and thus the discharge state maintaining margin is reduced. In this case, it is advantageous, for maintaining the discharge state of the fluorescent tube, to locate the elliptical portion having a high resistance in the vicinity of the high voltage electrode and locate the circular portion having a low resistance in the vicinity of the low voltage electrode (for example, in the vicinity of GND). This is easily understandable by performing a PWM dimming test.

A fluorescent tube having a circular cross-section (circular fluorescent tube) in a low duty state has a higher outer surface luminance in the vicinity of the high voltage electrode than in the vicinity of the low voltage electrode. For comparison, a fluorescent tube having one short side portion processed to have an elliptical cross-section was tested as follows. The elliptical portion was connected to the low voltage electrode and the circular portion was connected to the high voltage electrode. The fluorescent tube was driven in a low duty state by a PWM dimming test. In this structure, the discharge state at the elliptical portion was instable and a so-called snaking phenomenon was observed. This phenomenon appeared in a test performed at room temperature. Accordingly, it is clear that discharge would not properly occur if a similar test is performed at low temperature.

In the case where the elliptical portion was connected to the high voltage electrode and the circular portion was connected to the low voltage electrode as in this example, a stable discharge state was maintained as in the conventional fluorescent tube which is not processed to have an elliptical cross-section. This means that an effect unexpected to those skilled in the art was provided.

For processing a circular fluorescent tube so as to have an elliptical cross-section, a special jig having a softening point set to be slightly higher than the softening point of glass used can be used. The softening point of glass is about 700° C. The portion of the fluorescent tube to be processed is preheated by a burner and then a jig heated to about 800° C. is used to gradually deform the glass tube (fluorescent tube) to a prescribed size.

When performing such processing, it is necessary to pay attention to the high voltage electrode 55 and the low voltage electrode 58. The temperature of the high voltage electrode 55 and the low voltage electrode 58 becomes extremely high during heating. Therefore, when the inner surface of the glass tube contacts the high voltage electrode 55 and the low voltage electrode 58, the thermal deterioration of the high voltage rubber holder 54 and the low voltage rubber holder 59 is accelerated. The diameter of each electrode is 1.0 mm to 1.4 mm. When the glass tube is deformed without consideration of the size of the high voltage electrode 55 and the low voltage electrode 58, the inner surface of the glass tube contacts the high voltage electrode 55 and the low voltage electrode 58. Furthermore, there is another problem inherent in the production method of the fluorescent tube that the glass tube, the high voltage electrode 5 and the low voltage electrode 58 are not guaranteed to be parallel to each other. Accordingly, in this example, the high voltage electrode 55 and the low voltage electrode 58 are not deformed.

Next, various sizes and the electrical and optical characteristics of the conventional circular fluorescent tube and the elliptical fluorescent tube used in this example will be described.

One feature of the elliptical fluorescent tube used in this example is that a portion of the fluorescent tube having a high voltage electrode is processed to have an elliptical cross-section. As empirically perceived by those skilled in the art, when a normal glow discharge occurs inside the fluorescent tube before the fluorescent tube is lit up, discharge grows from the high voltage electrode to the low voltage electrode (for example, GND). It is known that the voltage at the start of lighting varies in accordance with the diameter of the fluorescent tube. However, no technology is currently available regarding an irregular fluorescent tube having an elliptical portion and a circular portion as the one used in this example. Tests performed by the present inventor for such an irregular fluorescent tube will be described.

Table 4 and Table 5 show various sizes and the electrical and optical characteristics of a conventional circular fluorescent tube.

TABLE 4

| | | | | | Gas volume in | | Short side |
|---|---|---|---|---|---|---|---|
| | Outer | Inner | Outer | Inner | the short side | Gas volume in | portion/entire tube |
| Item | diameter | diameter | circumference | circumference | portion | the entire tube | volume ratio |
| Conventional | 2.4 | 1.8 | 7.54 | 5.65 | 203.5 | 775.7 | 26.2% |
| | [mm] | [mm] | [mm] | [mm] | [mm²] | [mm²] | |

TABLE 5

| | | | | | Luminance at |
|---|---|---|---|---|---|
| | Inverter | | | Luminance at | the center of |
| | output voltage | Transducer output | | the center of | the liquid |
| | at the start of | voltage at the start of | Outer surface | the illumination | crystal display |
| Tube voltage | lighting | lighting | luminance | device | apparatus |
| 830 | 820 | 1150 | 37500 | 4722 | 374.9 |
| [Vrms] | [Vrms] | [Vrms] | [cd/m²] | [cd/m²] | [cd/m²] |
| at 6.5[mArms] | at −30[° C.] | at −30[° C.] | at 6.5[mArms] | at 6.5[mArms] | at 6.5[mArms] |
| | | | at +25[° C.] | at +25[° C.] | at +25[° C.] |
| | | | | D124/BEF2/D123 | LCP/lighting |

Table 4 shows the outer diameter, the inner diameter, the outer circumference, the inner circumference, the gas volume in the short side portion, the gas volume in the entire tube, and the short side portion/entire tube volume ratio of the conventional circular fluorescent tube.

Table 5 shows the electrical and optical characteristics of the conventional circular fluorescent tube: more specifically, the tube voltage, the inverter output voltage at the start of lighting, the transducer output voltage at the start of lighting, the outer surface luminance, the luminance at the center of the illumination device, and the luminance at the center of the liquid crystal display apparatus including the illumination device.

In Tables 4, 5 and 9, the voltage at the start of lighting was measured at room temperature −30° C., the outer surface luminance was measured at room temperature +25° C. and the electrical current of 6.5 mArms. As the inverter for lighting the fluorescent tube, HIU-288 produced by Harison Toshiba Lighting Corp. using a Ballast Capacitor 22 pF was used. The luminance was measured using BM-7 produced by Topcon Corporation.

In the fluorescent tube used in this example, the short side portion has a length of 80 mm, and the long aide portion has a length of 145 mm. The total length of the fluorescent tube is 305 mm. The fluorescent tube has a generally C-shaped planar shape. The outer diameter is 2.4 mm, and the inner diameter is 1.8 mm. The thickness of the glass is 0.3 mm. A glass thickness of less than 0.3 mm is not preferable since such glass, when bent into a general C-shape, is extremely deformed, which influences the discharge state. For this reason, glass having a thickness of 0.3 mm was used in this example. It is considered to be possible to use glass having a thickness of, for example. 0.25 mm when the processing method for the bent portions is improved in the future.

Tables 6 through 9 show various sizes and electrical and optical characteristics of the elliptical portion of the fluorescent tube used in this example (samples A through D) as compared to those of the conventional circular fluorescent tube (sample E).

TABLE 6

| | | | | | | | | Ratio of cross- | |
|---|---|---|---|---|---|---|---|---|---|
| | | | | Diameter | | | | sectional area of | Diameter of |
| | | | Radius along | along | | | | the elliptical | the elliptical |
| | | | the shorter | the shorter | Radius along | Diameter along | Cross- | portion with | portion |
| | | Shorter | axis of the | axis of the | the longer axis | the longer axis | sectional area | respect to that | converted to |
| | | axis/longer axis | elliptical | elliptical | of the elliptical | of the elliptical | of the elliptical | of the circular | the circular |
| Item | No. | ratio | cross-section | cross-section | cross-section | cross-section | portion | portion | portion |
| Present | A | 0.54 | 0.80 | 1.60 | 1.50 | 2.99 | 3.76 | −16.8% | 2.19 |
| Invention | B | 0.63 | 0.80 | 1.80 | 1.44 | 2.98 | 4.07 | −10.1% | 2.28 |
| | C | 0.73 | 1.00 | 2.00 | 1.37 | 2.74 | 4.31 | −4.8% | 2.34 |
| | D | 0.85 | 1.10 | 2.20 | 1.29 | 2.58 | 4.46 | −1.3% | 2.38 |
| Conventional | E | 1.00 | 1.20 | 2.40 | 1.20 | 2.40 | 4.52 | Reference | 2.40 |
| | | | [mm] | [mm] | [mm] | [mm] | [mm¹] | | [mm] |

Table 6 shows various sizes of the elliptical portion of the fluorescent tube used in this example regarding the outer circumference of the fluorescent tube; more specifically, the shorter axis/longer axis ratio, the radius along the shorter axis of the elliptical cross-section, the diameter along the shorter axis of the elliptical cross-section, the radius along the longer axis of the elliptical cross-section, the diameter along the longer axis of the elliptical cross-section, the cross-sectional area of the elliptical portion, the ratio of the cross-sectional area of the elliptical portion with respect to that of the circular portion, and the diameter of the elliptical portion converted to the circular portion.

TABLE 7

| | | | | | | | | Ratio of cross- | |
|---|---|---|---|---|---|---|---|---|---|
| | | | | Diameter | | | | sectional area of | Diameter of |
| | | | Radius along | along | | | | the elliptical | the elliptical |
| | | | the shorter | the shorter | Radius along | Diameter along | Cross- | portion with | portion |
| | | Shorter | axis of the | axis of the | the longer axis | the longer axis | sectional area | respect to that | converted to |
| | | axis/longer axis | elliptical | elliptical | of the elliptical | of the elliptical | of the elliptical | of the circular | the circular |
| Item | No. | ratio | cross-section | cross-section | cross-section | cross-section | portion | portion | portion |
| Present | A | 0.43 | 0.50 | 1.00 | 1.17 | 2.34 | 1.84 | −27.7% | 1.53 |
| Invention | B | 0.53 | 0.80 | 1.20 | 1.12 | 2.24 | 2.11 | −16.9% | 1.64 |
| | C | 0.66 | 0.70 | 1.40 | 1.06 | 2.13 | 2.34 | −8.1% | 1.73 |
| | D | 0.81 | 0.80 | 1.60 | 0.99 | 1.88 | 2.49 | −2.2% | 1.78 |
| Conventional | E | 1.00 | 0.90 | 1.80 | 0.90 | 1.60 | 2.54 | Reference | 1.80 |
| | | | [mm] | [mm] | [mm] | [mm] | [mm¹] | | [mm] |

Table 7 shows various sizes of the elliptical portion of the fluorescent tube used in this example regarding the inner circumference of the fluorescent tube; more specifically, the shorter axis/longer axis ratio, the radius along the shorter axis of the elliptical cross-section, the diameter along the shorter axis of the elliptical cross-section, the radius along the longer axis of the elliptical cross-section, the diameter along the longer axis of the elliptical Cross-section, the cross-sectional area of the elliptical portion, the ratio of the cross-sectional area of the elliptical portion with respect to that of the circular portion, and the diameter of the elliptical portion converted to the circular portion.

TABLE 8

| | | | | | | | Transducer |
|---|---|---|---|---|---|---|---|
| | | | | | | Inverter output | output voltage |
| | | | Reduction of | | | voltage at the | at the start of |
| Item | No. | Gas volume | gas volume | Gas pessure | Tube voltage | start of lighting | lighting |
| Present | A | 719.3 | −7.3% | 64.4 | 676 | 880 | 1234 |
| invention | B | 741.4 | −4.4% | 62.7 | 658 | 856 | 1201 |
| | C | 759.2 | −2.1% | 61.3 | 643 | 837 | 1175 |
| | D | 771.2 | −0.6% | 60.4 | 634 | 825 | 1167 |
| Conventional | E | 775.7 | Reference | 60.0 | 630 | 820 | 1150 |
| | | [mm²] | | [Torr] | [Vrms] | [Vrms] | [Vrms] |
| | | | | | at 6.5[mArms] | at −30[° C.] | at −30[° C.] |

Table 8 shows the gas volume, the reduction of gas volume, the gas pressure, the tube voltage, the inverter output voltage at the start of lighting, and the transducer output voltage at the start of lighting. The tube voltage, the inverter output voltage at the start of lighting, and the transducer output voltage at the start of lighting were measured while varying the shorter axis/longer axis ratio.

TABLE 9

| | | | Outer surface | Outer surface | Luminance | Luminance at | |
|---|---|---|---|---|---|---|---|
| | | Outer surface | luminance when | luminance when | at the center of | the center of the | |
| | | luminance of the | seen in the shorter | seen in the longer | the illumination | liquid crystal | Increase |
| Item | No. | circular portion | axis direction | axis direction | device | display apparatus | In luminance |
| Present | A | 40230 | 42700 | 32300 | 5250 | 416.8 | 11.2% |
| invention | B | 39260 | 40660 | 34340 | 5053 | 401.2 | 7.0% |
| | C | 38300 | 39030 | 35980 | 4874 | 387.0 | 3.2% |
| | D | 37720 | 37920 | 37080 | 4764 | 378.2 | 0.9% |
| Conventional | E | 37500 | 37500 | 37500 | 4722 | 374.9 | [symbol] Reference |
| | | [cd/m²] | [cd/m²] | [cd/m²] | [cd/m²] | [cd/m²] | |
| | | at 6.5[mArms] | at 6.5[mArms] | at 6.5[mArms] | at 6.5[mArms] | at 6.5[mArms] | |
| | | at +25[° C.] | at +25[° C.] | at +25[° C.] | at +25[° C.] | at +28[° C.] | |
| | | | | | D124/BEF2/D123 | LCP/Lighting | |

Table 9 shows the electrical and optical characteristics of the elliptical fluorescent tube used in the present invention as compared to those of the conventional fluorescent tube. More specifically, Table 9 shows the outer surface luminance of the circular portion, the outer surface luminance when the fluorescent tube is seen in the direction of the shorter axis (arrow A in FIG. 4A), the outer surface luminance when the fluorescent tube is seen in the direction of the longer axis (arrow a in FIG. 4A), the luminance at the center of the illumination device, the luminance at the canter of the liquid crystal display apparatus including the illumination device, and the increase in luminance.

As shown in Tables 6 through 8, when the fluorescent tube is processed to have an elliptical cross-section, the inner cross-sectional area of the tube is reduced as compared to the state of having a circular cross-section. Since the gas enclosed in the glass tube has no place to escape, the inner gas pressure is increased in correspondence with the reduction in the cross-sectional area. Such a change in the inner gas pressure provides the greatest electrical and optical influences.

Regarding the electrical characteristics, as shown in Table 8, the tube voltage while the fluorescent tube is lit, and the voltage at the start of lighting, increase as the shorter axis/longer axis ratio of the elliptical cross-section decreases.

Regarding the optical characteristics, as shown in Table 9, the luminance increases as the shorter axis/longer axis ratio of the elliptical cross-section decreases since the inner gas pressure increases. As shown in Table 9, the luminance when the fluorescent tube is seen in the shorter axis direction (arrow A in FIG. 4A) is higher than the luminance when the fluorescent tube is seen in the longer axis direction (arrow B in FIG. 4A). Utilizing this the fluorescent tube is located such that the longer axis direction (low luminance) of the elliptical cross-section is parallel to the light incident surface 4c of the optical conductor 4. Thus, the longer axis direction is substantially perpendicular to a direction vertical to the light incident surface 4c. In this state, the light with a higher luminance in the shorter axis direction is incident on the light incident surface 4c of the optical conductor 4. As a result, the amount of light incident on the optical conductor 4 is increased.

Since the fluorescent tube has a high luminance, the light scattering resin section 2 is formed of a resin containing a light scattering material in order to reduce the luminance, and thus in order to prevent the light emitted by the fluorescent tube 1 and transmitted through the light scattering resin section 2 from influencing the display. Also, the fluorescent tube 1 is located such that the longer axis direction of the elliptical cross-section faces the thin plate portion 4d for reducing the luminance. Thus, even when the light scattering resin section 2 is relatively short, the uniformity of the luminance of the frame area and the vicinity thereof does not deteriorate. Since the optical margin is larger than that of conventional illumination devices, a slight error during the production of the light scattering resin section 2 causes no serious problems. Thus, it is not necessary to perform a strict examination, which reduces the production cost of the optical conductor 4.

As shown in Table 8, even when the fluorescent tube is processed to have an elliptical cross-section, the electrical characteristics do not deteriorate. The tube voltage and the voltage at the start of lighting tends to be higher than those of the circular fluorescent tube, but the increase is 15% or less, or even as low as 10% or less in some cases. Thus, the fluorescent tube can be driven well within the lighting margin which is set when designing the inverter. Accordingly, an illumination device having a very narrow frame area 18 provided which does not have any optical disadvantage and has sufficiently acceptable electric characteristics.

As shown in Tables 8 and 9, when the shorter axis/longer axis ratio of the elliptical cross-section decreases, the outer surface luminance in the shorter axis direction increases and the inner gas pressure increases. By the synergistic effect of these increases, the luminance at the center of the illumination device increases. The luminance was compared using a conventional optical sheet. For example, in sample B in which the shorter axis/longer axis ratio was 0.63, the luminance was increased by 7%. This confirms that processing a fluorescent tube so as to have an elliptical cross-section effectively contributes to the increase in luminance at the center of the illumination device. Such an increase in luminance is still provided even when the illumination device is combined with a liquid crystal panel. A liquid crystal display apparatus including the illumination device and the liquid crystal panel has a correspondingly increased luminance.

In order to obtain an optimal elliptical shape, it is necessary to consider a structural factor of the thickness of the illumination device. The fluorescent tube 1 is located in a space between the thin plate portion 4d of the optical conductor 4 and a level about 3.0 mm therebelow. As shown in Table 6, when the shorter axis/longer axis ratio is 0.53, the diameter along the longer axis is 2.99 mm, with which there is substantially no clearance. Since it is not preferable for actual mass-production to design a product with no clearance, it is not preferable to process the fluorescent tube so as to have such a ratio. When the shorter axis/longer axis ratio is 0.63, the diameter along the longer axis is 2.88 mm. The designing margin is very small but is acceptable in consideration of the processing tolerance of the fluorescent tube for an elliptical cross-section. Accordingly, the lower limit of the shorter axis/longer axis ratio can be a numerical value which is between 0.53 and 0.63 and closer to 0.63, for example, 0.6. The shorter axis/longer axis ratio for the fluorescent tube 1 in this example is preferably 0.6 or greater and less than 1.0.

As described above, use of an elliptical fluorescent tube 1 realizes an illumination device 10 providing a high luminance with a very small frame area while suppressing the electrical influences to +10% or less. Owing to this, a high luminance transmission type liquid crystal display apparatus is realized, and the luminance of a transmission type liquid crystal display having a reflection function is improved to a practical level. Therefore, the present invention provides superb illumination devices and liquid crystal display apparatuses of various types which comply with the demands of the market or customers regarding the luminance and display quality.

In the above description, the present invention is applied to a fluorescent tube having a generally C-shaped planar shape. The present invention is also applicable to a fluorescent tube having a generally L-shaped, O-shaped or straight planar shape, or a combination thereof.

### Embodiment 3

In Embodiment 1, various tests were performed in order to improve the structure of illumination device 10 of the liquid crystal display apparatus 100 and the combination of the sheets forming the optical sheet, i.e. the transmittance of the optical sheet. Specifically, the turbidity of the upper diffusion sheet 7 was varied (Table 1). A selective polarization reflective film was used instead of the upper diffusion sheet 7 in order to match the optical axis of the light emitted by the illumination device 10 to a specific polarization axis (Table 2). A selective polarization reflective film was used instead of the upper diffusion sheet 7 in order to provide appropriate visibility even under external light (Table 3). In Embodiment 2, the structure of an elliptical fluorescent tube 1 usable in the present invention and the electrical and optical characteristics thereof are described.

In Embodiment 2, the structure and the electrical and optical characteristics of the elliptical fluorescent tube according to the present invention are described. More specifically, the following arrangement of a fluorescent tube having a generally C-shaped planar shape is described: an elliptical portion of the fluorescent tube is connected to a high voltage electrode, the longer axis direction (low luminance) of the elliptical cross-section faces the thin plate portion 4d, and the shorter axis direction (high luminance) of the elliptical cross-section faces the light incident surface 4c. It is also described that the lower limit of the shorter axis/longer axis ratio to 0.6 or greater and less than 1.0.

In Embodiment 3, the location of the fixing sub material used for the liquid crystal display apparatus 100 and the measurement results of the luminance at various points of measurement from the vicinity of an end of the effective display area to the center of the effective display area of the illumination device will be described. The effective display area of the illumination device corresponds to the effective display area of the liquid crystal panel.

First, the locations of the fixing sub material in the liquid crystal display apparatus 100 (FIG. 1) according to the present invention and the conventional liquid crystal display apparatus 200 (FIG. 6) will be compared.

In the conventional liquid crystal display apparatus 200 (FIG. 6), the rear housing 231 and the reflective plate 203 of the illumination device 210 are fixed together with the two-sided adhesive tape 241 acting as a fixing sub material at a position which is inner to the light incident surface 204a of the optical conductor 204 and is away from the fluorescent tube 201.

According to the present invention, the two-sided adhesive tape 41 acting as a fixing sub material is located below the light incident surface 4c of the optical conductor 4, the fluorescent tube 1, and the optical conductor 4, as shown in FIG. 1.

The fixing sub material is preferably located at this position for the following reason. At the position where the two-sided adhesive tape 41 acting as the fixing submaterial is provided, the reflective plate 3 is slightly raised by the influence of the thickness of the fixing sub material. Therefore, when the reflective plate 3 is raised in the vicinity of the bottom surface of the light incident surface 40, the optical conductor 4 and the reflective plate 3 become close to each other. Thus, the gap between the bottom surface 4b of the optical conductor 4 in the vicinity of the light incident surface 4a and the reflective plate 3 is reduced, and the light directly emitted from the fluorescent tube 1 and the light scattered and/or reflected by the thin plate portion 4d is prevented from coming into the gap.

In the case of the liquid crystal display apparatus 200 shown in FIG. 6, where the two-sided adhesive tape 241 acting as a fixing sub material is located inside and far from the light incident surface 204a of the optical conductor 204, a gap is made between the bottom surface 204b of the optical conductor 204 in the vicinity of the light incident surface 204c and the reflective plate 203. Therefore, light goes into this gap. As a result, a bright area is generated in a large area to such a degree that the viewer feels uncomfortable by the light diffusion and scattering means (not shown) provided on the bottom surface 204b of the optical conductor 204. Thus, the luminance uniformity of the illumination device 210 deteriorates. Due to the influence of the variance in the assembling operation of the illumination device 210 and difference in position at which the fixing sub material is located in accordance with, for example, the size of the optical components and the size of the housings, the gap between the reflective plate 203 and the bottom surface 204b of the optical conductor 204 is caused to become larger or smaller. Thus, the size of the gap cannot be controlled, and the dispersion in display cannot be suppressed.

According to the present invention, the position of the two-sided adhesive tape 41 acting as a fixing sub material is set such that the thickness of the fixing sub material 41 effectively contributes to appropriate contact between the reflective plate 3 and the bottom surface 4b of the optical conductor 4 in the vicinity of the light incident surface 4c. Thus, there is substantially no gap between the light incident surface 4c and the reflective plate 3, which suppresses stray light from being incident on the light incident surface 4c.

In this example, as the two-sided adhesive tapes 41 through 44 each acting as a fixing sub material, #6046 (two-sided adhesive tape produced by Kuramoto Sangyo Co.; total thickness: 75 m) was used. This two-sided adhesive tape has a feature of having a strong light resistance. In general, the color of an acrylic two-sided adhesive tape is changed to a yellowish color by the ultraviolet rays emitted by the fluorescent tube 1. The tape used in this example suppresses such a color change. #6046 is described in detail in Japanese Application No. 2002-182794, and will not be described herein. Such a two-sided adhesive tape having a strong light resistance is very effective as the tape 41 is not optically influenced by the ultraviolet even when there is light incident on the two-sided adhesive tape 41 through the reflective plate 3. Thus, the optical components can be fixed stably for a long period of time.

Next, the results of measurement of the luminance at various points from an end of the effective display area to the center thereof regarding the illumination device 10 and the conventional illumination device 210 will be described.

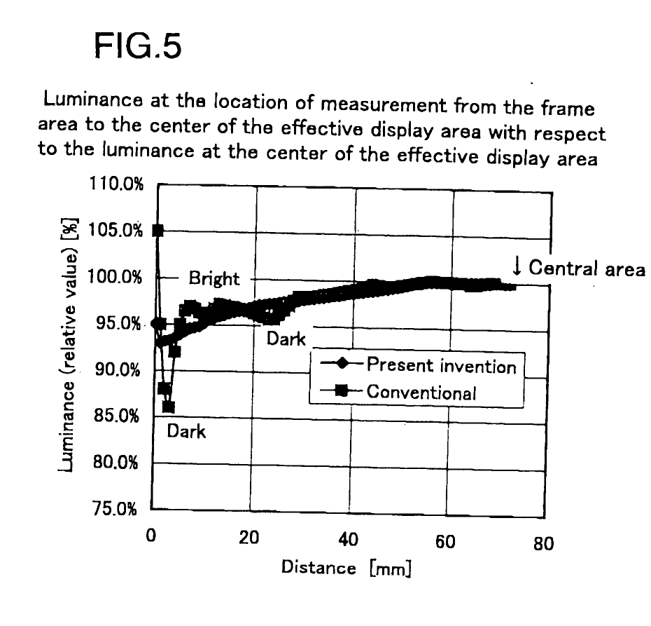

Table 10 compares the luminance measured at various locations from the frame area to the center of the effective display area of the illumination device 10 according to the present invention and the conventional illumination device 210. FIG. 5 is a graph illustrating the results.

TABLE 10

| | |
|---|---|
| | Luminance with respect |
| | to the luminance at the |
| | center of effective |
| Point | display area(100%) |

| of | Present | |
|---|---|---|
| measurement | invention | Conventional |
| 0 | 95.0% | 105.0% |
| 1 | 93.0% | 95.0% |
| 2 | 93.2% | 88.0% |
| 3 | 93.3% | 86.0% |
| 4 | 93.6% | 92.0% |
| 5 | 93.9% | 95.0% |
| 6 | 94.2% | 96.5% |
| 7 | 94.8% | 97.0% |
| 8 | 94.7% | 96.8% |
| 9 | 94.8% | 96.3% |
| 10 | 95.2% | 95.9% |
| 11 | 96.6% | 96.3% |
| 12 | 95.8% | 96.8% |
| 13 | 95.9% | 97.2% |
| 14 | 96.1% | 97.1% |
| 15 | 98.3% | 97.0% |
| 16 | 96.4% | 96.9% |
| 17 | 96.6% | 96.8% |
| 18 | 96.7% | 96.7% |
| 19 | 96.9% | 96.8% |
| 20 | 97.1% | 96.3% |
| 21 | 97.2% | 96.1% |
| 22 | 97.3% | 95.9% |
| 23 | 97.4% | 95.7% |
| 24 | 97.4% | 95.7% |
| 25 | 97.5% | 96.2% |
| 26 | 97.6% | 96.7% |
| 27 | 97.7% | 97.2% |
| 28 | 97.7% | 97.7% |
| 29 | 97.8% | 98.2% |
| 30 | 97.9% | 98.2% |
| 31 | 98.0% | 98.1% |
| 32 | 98.0% | 98.2% |
| 33 | 98.1% | 98.3% |
| 34 | 98.2% | 98.4% |
| 35 | 98.3% | 98.5% |
| 36 | 98.3% | 98.6% |
| 37 | 98.4% | 98.7% |
| 38 | 98.5% | 98.8% |
| 39 | 98.6% | 98.9% |
| 40 | 98.6% | 99.0% |
| 41 | 98.7% | 99.1% |
| 42 | 98.8% | 99.2% |
| 43 | 98.9% | 99.4% |
| 44 | 98.9% | 99.6% |
| 45 | 99.0% | 99.6% |
| 46 | 99.1% | 99.5% |
| 47 | 99.2% | 99.5% |
| 48 | 99.3% | 99.4% |
| 49 | 99.4% | 99.5% |
| 50 | 99.5% | 99.6% |
| 51 | 99.6% | 99.7% |
| 52 | 99.7% | 99.8% |
| 53 | 99.8% | 99.8% |
| 54 | 99.9% | 99.9% |
| 55 | 100.0% | 100.0% |
| 56 | 100.0% | 100.1% |
| 57 | 100.0% | 100.1% |
| 58 | 100.0% | 100.0% |
| 59 | 100.1% | 100.0% |
| 60 | 100.1% | 100.0% |
| 61 | 100.0% | 99.9% |
| 62 | 100.0% | 99.9% |
| 63 | 100.0% | 99.9% |
| 64 | 100.0% | 99.7% |
| 65 | 100.0% | 99.8% |
| 66 | 100.0% | 99.9% |
| 67 | 100.0% | 99.9% |
| 68 | 100.0% | 100.0% |
| 69 | 100.0% | 100.0% |
| 70 | 100.0% | 100.0% |
| 71 | 100.0% | 100.0% |
| 72 | 100.0% | 100.0% |
| | | [mm] |

In the illumination device 10 according to the present invention, the fixing sub material 41 is located in the vicinity of the bottom surface of the light incident surface 4a of the optical conductor 4. In the conventional illumination device 210 (FIG. 6), the fixing sub material 241 is located inside and far from the light incident surface 204a of the optical conductor 204.

Table 10 shows the luminance at various points of measurement between the frame area and the center of the effective display area of the illumination device. The luminance is represented as a relative value with respect to the luminance at the center of the effective display area. The luminance at the center of the effective display area is set as 100%. In FIG. 5, the horizontal axis represents the points between the frame area to the center of the effective display area, and the vertical axis represents the relative value of the luminance. The solid line represents the relative luminance of the illumination device according to the present invention, and the dotted line represents the relative luminance of the conventional illumination device 200.

As can be appreciated from Table 10 and FIG. 5, in the case of the conventional illumination device 210, the luminance drastically decreases in the vicinity of the light incident surface 204c of the optical conductor 204 and drastically increases in the frame area of the illumination device 210. The luminance goes up and down toward the inside of the optical conductor 204. When such a change in luminance occurs, the human eye sees that a bright line or a dark line is generated in an area where the differential value is 0, i.e., where the differentiation value of the luminance is inverted from a positive value to a negative vale or vice versa.

In the case of the illumination device 10 according to the present invention, the luminance shows an ideal curve which gradually increases from the frame area to the center of the effective display area. The change in luminance can be suppressed in the frame area and the vicinity thereof for the following reasons: (i) the gap between the bottom surface 4b of the optical conductor 4 and the reflective plate 3 is decreased in the vicinity of the bottom surface of the light incident surface 4c of the optical conductor 4 as described in Embodiment 3: (ii) the outer end of the overlapping thin plate section 4d/portion 2b of the light scattering resin section 2, i.e. the end b of the thin plate section 4d, is located outside a border plane a between the effective display area 21 and the frame area 22 as described in Embodiment 1; and (iii) the fluorescent tube is processed to have an elliptical cross-section as described in Embodiment 2.

As described in Embodiments 1 through 3, in the illumination device 10 including a light source, for example, the fluorescent tube 1 provided in the vicinity of the light incident surface 4c and the thin plate portion 4d of the optical conductor 4, the portion 2b of the light scattering resin section 2 and the thin plate 4d formed of a light-transmissive resin are provided in an overlapped state. The outer end of the overlapping thin plate section 4d/portion 2b of the light scattering resin section 2, i.e., the end b of the thin plate section 4d, is located outside the border plane a between the effective display area 21 and the frame area 22. Therefore, even when the liquid crystal panel 20 is observed in an oblique direction c, the viewer is not aware of the existence of the outer end of the overlapping thin plate section 4d/portion 2b of the light scattering resin section 2. Therefore, no hue change is observed at the border b or the vicinity thereof. Since the fluorescent tube 1 has an elliptical cross-section, the frame area can be further narrower than when a conventional circular fluorescent tube is used. Therefore, an improved uniformity of the light output surface and display surface and continuous change of luminance when the liquid crystal panel is seen in an oblique direction c which has an angle d with respect to the border plane a are provided together with the significant reduction in the frame area. Thus, the electrical and optical characteristics can be maintained at a high level.

As described above, according to the present invention, the end of the projection of the optical conductor is outside the effective display area of the liquid crystal panel. Therefore, a higher luminance continuity at the light output surface than that of the conventional illumination device is guaranteed. When the viewer watches the liquid crystal panel placed on the illumination device, the viewer is not aware of the end of the projection of the optical conductor in the frontal viewing direction or an oblique direction. Thus, a high display quality is guaranteed by uniform displays

According to the present invention, the linear light source having an elliptical cross-section, for example, an elliptical fluorescent tube is used. As compared to the case where a circular fluorescent tube is used, the size of the projection of the optical conductor is shortened in a direction parallel to the light output surface. Therefore, an illumination device having a very narrow frame area can be realized. In the case where the light source is provided such that the longer axis direction is substantially perpendicular to a direction vertical to the light incident surface of the optical conductor, the outer surface luminance in the longer axis direction is lower than that of the circular fluorescent tube. Thus, the luminance change in the frame area of the illumination device can be suppressed. Since the outer surface luminance in the shorter axis direction is higher than that of the circular fluorescent tube, the amount of light incident on the optical conductor increases and the overall luminance of the illumination device can be improved. Thus, the illumination device according to the present invention has a very narrow frame area strongly demanded by the market and the customers can be realized, and also provides a high luminance since the high level of electrical and optical characteristics of the conventional illumination device are maintained.

A fixation section used for fixing the illumination device to, for example, a housing is provided below the light incident surface. Owing to such a structure, the bottom surface of the optical conductor in the vicinity of the light incident surface and the reflective plate have a reduced gap therebetween, or are in contact with each other. The amount of light coming into this gap can be reduced or made zero. This suppresses or prevents unnecessary reflection of the stray light coming into a space between the bottom surface of the light incident surface of the optical conductor and the reflective plate. This reduces or prevents abnormal luminance variance and luminance change in the vicinity of the light incident surface of the optical conductor. Accordingly, by providing the fixation section as described above, a liquid crystal display apparatus having a superior display quality than that of the conventional liquid crystal display apparatus can be provided.

The present invention is applicable to fluorescent tubes having a straight, generally C-shaped, generally L-shaped, or generally O-shaped planar shape. A portion of the fluorescent tube along which the frame area needs to be narrowed is processed to have an elliptical cross-section. In this manner, a very narrow frame area desired by the market or the customers can be realized.

The elliptical fluorescent tube is formed by changing the shape of the cross-section of a circular fluorescent tube by, for example, deformation. Therefore, even after the processing, the fluorescent tube maintains a cross-sectional area which is sufficient for normal glow discharge. Even an increase in the inner, enclosed gas pressure can be suppressed to be small. Accordingly, the electrical and optical characteristics of the post-processing fluorescent tube are not significantly different from those of the circular fluorescent tube. The voltage at the start of lighting is increased by +15% or less, the driving voltage is increased by within +10% inclusive, an the average outer surface luminance is increased by within ±15% inclusive. Therefore, conditions for optical designing and for the illumination device can be similar to those of the conventional illumination device. The shorter axis/longer axis ratio is limited to 0.6 or greater and less than 1.0. Thus, a sufficient margin for processing in obtained.

The present invention provides a transmission type liquid crystal display apparatus and a transmission type liquid crystal display apparatus having a reflection function which have a very narrow frame area and electrical and optical characteristics equal to those of the conventional liquid crystal display apparatus, which provide a high luminance and a high uniformity, and which have a satisfactory display quality even seen in an oblique direction.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. An illumination device for illuminating a liquid crystal panel having a frame area and an effective display area surrounded by the frame area, the illumination device comprising:
a light source for emitting light;
an optical conductor including a light incident surface on which light emitted by the light source is allowed to be incident, a light output surface from which the light is allowed to be output, and a projection projecting from the light incident surface; and
a light scattering section for scattering light, the light scattering section including an engaging portion which is engageable with the projection;
wherein the optical conductor and the light scattering section are located such that an end of the projection of the optical conductor is located outside the effective display area of the liquid crystal panel.

2. An illumination device according to claim 1, wherein the projection includes a thin plate portion which is shaped like a thin plate.

3. An illumination device according to claim 1, wherein the projection is located closer to the light output surface than a bottom surface of the optical conductor facing the light output surface.

4. An illumination device according to claim 1, wherein the light scattering section includes a plate-like light scattering section.

5. An illumination device according to claim 1, wherein:
the light scattering section includes a first portion and a second portion which is thinner than the first portion, and the engaging portion has a step formed by the first portion and the second portion; and
the projection is located so as to overlap with a surface of the second portion.

6. An illumination device according to claim 1, wherein the light source includes a linear light source.

7. An illumination device according to claim 5, wherein a surface of the first portion of the light scattering section, a surface of the projection of the optical conductor, and the light output surface of the optical conductor are substantially in an identical plane with each other.

8. An illumination device according to claim 1, wherein the light source is structured such that an area of a portion of the light source facing the light incident surface of the optical conductor is larger than an area of a portion of the light source facing the light scattering section.

9. An illumination device according to claim 8, wherein the light source has an elliptical cross-section.

10. An illumination device according to claim 9, wherein the light source is located such that a longer axis direction of the elliptical cross-section to substantially perpendicular to a direction vertical to the light incident surface of the optical conductor.

11. An illumination device according to claim 8, wherein the light source is a fluorescent tube having at least one bending portion, and at least one portion of the fluorescent tube is processed to have an elliptical cross-section.

12. An illumination device according to claim 11, wherein:
the light source is provided with a first electrode to which a first voltage is allowed to be applied and a second electrode to which a second voltage lower than the first voltage is allowed to be applied; and
the at least one portion of the fluorescent tube which is processed to have an elliptical cross-section is located closer to the first electrode than the second electrode.

13. An illumination device according to claim 1, wherein the light source includes a fluorescent tube processed to have an elliptical cross-section and an electrode which is not processed to have an elliptical cross-section.

14. An illumination device according to claim 10, wherein the ratio of the length of a longer axis of the elliptical cross-section with respect to the length of a shorter axis of the elliptical cross-section is 0.6 or greater and less than 1.0.

15. An illumination device according to claim 14, wherein:
the fluorescent tube is processed to have an elliptical cross-section; and
with respect to the fluorescent tube before being processed, the post-processing fluorescent tube has a voltage at the start of lighting increased by more than 0% and +15% or less, has a driving voltage increased by more than 0% and +10% or leas, and an average outer surface luminance changed by within ±15% inclusive.

16. An illumination device according to claim 5, wherein an end of the second portion of the light scattering section is located inside the light incident surface and is in contact with the optical conductor.

17. An illumination device according to claim 1, further comprising an optical sheet located on the light output surface.

18. An illumination device according to claim 17, wherein the optical sheet includes a combination of a low turbidity diffusion sheet and a high turbidity diffusion sheet.

19. An illumination device according to claim 17, wherein the optical sheet includes a combination of a selective polarization reflective section and a high turbidity diffusion sheet.

20. An illumination device according to claim 1, further comprising:
a fixation section located below the light incident surface of the optical conductor; and
a reflection section for reflecting light which is output from a bottom surface of the optical conductor which faces the optical output surface of the optical conductor, the reflection section being located between the fixation section and the optical conductor.

21. An illumination device according to claim 20, wherein a surface of the reflection section and the bottom surface of the optical conductor are in contact with each other below the light incident surface of the optical conductor.

22. A liquid crystal display apparatus, comprising:
an illumination device according to claim 1; and
a transmissive liquid crystal panel for performing display by allowing light emitted by the illumination device to transmit therethrough or shielding the light.

23. A liquid crystal display apparatus, comprising:
an illumination device according to claim 1; and
a transmissive liquid crystal panel having a reflection function for performing display by allowing light emitted by the illumination device to transmit therethrough or shielding the light, and also performing display by reflecting external light.
